(19) United States
(12) Patent Application Publication
(10) Pub. No.: US 2018/0370119 A1
(43) Pub. Date: Dec. 27, 2018

(54) ENERGETIC THERMOPLASTIC FILAMENTS FOR ADDITIVE MANUFACTURING AND METHODS FOR THEIR FABRICATION

(71) Applicant: Capco, LLC, Grand Junction, CO (US)

(72) Inventors: Theodore Ronald Spence, Grand Junction, CO (US); Christopher Floyd Williams, Grand Junction, CO (US)

(21) Appl. No.: 15/925,735

(22) Filed: Mar. 19, 2018

Related U.S. Application Data
(60) Provisional application No. 62/473,104, filed on Mar. 17, 2017.

(51) Int. Cl. B29C 64/118; C06B 23/00; B29C 47/38; C06B 21/00; C08L 71/02

(52) U.S. Cl. CPC B29C 64/118; C06B 23/001; C08G 65/18; C06B 21/005; C08L 71/02; B29C 47/385

(57) ABSTRACT

An energetic thermoplastic filament comprising an energetic material bound within a thermoplastic matrix and methods for the fabrication of an energetic thermoplastic filament are disclosed. The energetic material comprises an energetic material selected from an explosive, a propellant, a pyrotechnic, an oxidizer, or combinations thereof. The thermoplastic comprises a TPE, ETPE, or combinations thereof. The thermoplastic filaments may be formed by extrusion. The energetic thermoplastic filaments are particularly suitable for additive manufacturing by thermal FDM style 3D printing systems.

### CROSS-REFERENCE TO RELATED APPLICATIONS

This application claims the priority benefit of U.S. Provisional Patent Application No. 62/473,104, filed on Mar. 17, 2017, which is incorporated herein by reference in its entirety.

### FIELD

This disclosure relates to the field of energetic devices, and in particular to energetic thermoplastic filaments that are useful for the fabrication of energetic devices.

### BACKGROUND

Additive manufacturing (“AM”), also known as 3D printing, facilitates the building of three-dimensional objects by adding successive material layers. AM has the potential to transform explosives technology, enabling novel behaviors such as directional detonation, precisely tunable burn rates, increased lethality, reduced size, and improved insensitive response.

The majority of the current explosives 3D printers used in Department of Defense (DoD), Department of Energy (DoE), and private industry labs use syringe-based techniques to deposit pastes or slurries (“inks”) consisting of thermites, nitramines or oxidizers mixed with polymeric fuels or binders such as hydroxyl-terminated polybutadiene (HTPB), ultraviolet curable resins, or nitrocellulose-based materials. While these formulations have shown great promise, the syringe-based techniques do not lend themselves to the most common variety of commercial, off-the-shelf (COTS) 3D printers—fused deposition modelling (“FDM”) printers that extrude thermoplastic filaments.

### SUMMARY

Thermal FDM printers are ubiquitous, relatively inexpensive, and easy to maintain. Furthermore, thermoplastic filaments can be spooled in arbitrarily long lengths, allowing for near-continuous processing for high volume production. Waste and cleanup are minimal, especially in comparison to stereo-lithography and powder-bed printers. The development of energetic thermoplastic filaments for COTS 3D printers would provide an immediate benefit to the energetics community.

Polymers have served extensively as binders and plasticizers for energetic materials. The polymers provide desired physical properties and act as a primary or secondary fuel source for energetic formulations. Polymers can be used in plastic-bonded explosives (PBXs), propellants, and pyrotechnics to achieve performance metrics, thermal stability, insensitivity, and shock and vibration resistance.

With the maturation of energetic materials, diverse classes of polymers have been developed for binder applications in order to meet objectives of insensitive response, high performance, and manufacturability. Examples include the ability for warheads to be machined safely, the durability of countermeasures to withstand vibration and shock in the field, and the insensitivity of munitions to withstand cook-off, bullet and fragment impact, and sympathetic detonation.

Conventional binders for energetic materials use cross-linked elastomers such as hydroxyl terminated polybutadiene (HTPB). Drawbacks of such a cast-cure binder are pot life, non-recyclability, and high mix viscosity. The disadvantages of cross-linked elastomeric binders have been addressed by thermoplastic elastomers (TPEs). TPEs contain soft and hard polymeric blocks which give the polymer its elastomeric and thermoplastic properties, respectively. The thermoplastic property facilitates melt-cast processing. TPEs have previously been used for energetic material applications, as described in U.S. Pat. No. 4,806,613 by Wardle and U.S. Pat. No. 4,361,526 by Allen, each of which is incorporated herein by reference in its entirety.

Inert cast-cure and TPE binders have excellent physical properties, but they reduce the energetic output of the composition. Energetic thermoplastic elastomers (ETPE) are more appealing, as they provide additional energy and insensitivity to formulations as compared with their inert counterparts.

The desire to achieve higher performance while maintaining manufacturability and insensitivity has led to the development of ETPEs. Like TPEs, ETPEs are composed of soft and hard polymeric blocks. ETPEs differ from TPEs in that the starting copolymers are energetic, and as a result, greater energy is released with ETPEs than TPEs upon combustion.

Cost and environmental concerns are drivers for the development of next-generation energetic materials. ETPEs have provided a paradigm shift in the processing of energetic material formulations by replacing the chemical cast-cure process with an environmentally friendly melt-cast process. Melt-cast processing enables greener chemistry, recyclability, and reprocessing. Additionally, the inventors have recognized that melt cast processing is well suited for FDM 3D printing.

In one embodiment, a method for the fabrication of an energetic thermoplastic filament is disclosed. The method includes the steps of providing an energetic thermoplastic filament composition to an extruder, the thermoplastic filament composition comprising an energetic material and a thermoplastic elastomer, extruding the filament composition through an orifice of a heated nozzle to from an extrudate, and reducing the temperature of the extrudate to immobilize the energetic material within a thermoplastic matrix and form the energetic thermoplastic filament.

In another embodiment, an energetic thermoplastic filament is disclosed. The filament includes an energetic material and a thermoplastic elastomer, wherein the energetic material is bound and immobilized homogeneously within a thermoplastic elastomer matrix.

### DESCRIPTION OF THE DRAWINGS

FIG. 1 illustrates various examples of 3 mm diameter thermoplastic filaments according to the present disclosure.

FIG. 2 illustrates cross sections of three energetic thermoplastic filaments according to the present disclosure at 50× magnification.

FIG. 3 illustrates a flow chart for the manufacture of energetic thermoplastic filaments according to the present disclosure.

FIG. 3 illustrates a flow chart for the manufacture of energetic thermoplastic filaments.

FIG. 4 illustrates a differential scanning calorimetry/thermogravimetric analysis (DSC/TGA) thermogram of HMX.

FIG. 5 illustrates a DSC/TGA thermogram of HMX/TPE 90/10.

FIG. 6 illustrates a DSC/TGA thermogram of HMX/TPE 70/30.

FIG. 7 illustrates a DSC/TGA thermogram of HMX/TPE 50/50.

FIG. 8 illustrates a DSC/TGA thermogram of ammonium perchlorate (AP)/TPE 74/26.

FIG. 9 illustrates a DSC/TGA thermogram of TPE.

### DESCRIPTION OF THE EMBODIMENTS

In one embodiment, the present disclosure is directed to methods for the fabrication of energetic thermoplastic filaments, e.g., filaments that may be suitable for use as a feedstock for COTS and custom FDM 3D printers. An energetic thermoplastic filament according to the present disclosure includes an energetic material and a thermoplastic elastomer, where the energetic material is bound and homogeneously immobilized within a matrix of the thermoplastic elastomer.

As used herein, the term energetic material encompasses those materials known to those skilled in the art as high explosives, propellants, pyrotechnics, fuels, oxidizers, and modifying agents.

Thus, in one embodiment, the energetic material comprises an explosive formulation, e.g., a high explosive formulation. The explosive formulation may include at least one of a primary explosive, a secondary explosive, a tertiary explosive, and mixtures thereof. For example, the explosive formulation may include an explosive that is selected from the group consisting of 1,3,5-trinitroperhydro-1,3,5-triazine (RDX), octahydro-1,3,5,7-tetranitro-1,3,5,7-tetrazocine (HMX, or octogen), hexanitrohexaazaisowurtzitane (CL-20), hexanitrostilbene (HNS), pentaerythritol tetranitrate (PETN), 2,4-dinitroanisole (DNAN), 1,3,3-trinitroazetidine (TNAZ), 1,3,5-tria ino-2,4,6-trinitrobenzene (TATB), and combinations thereof. Other explosive compounds and formulations will be apparent to those of skill in the art. When the energetic filament includes an explosive, the explosive is preferably contained in the energetic thermoplastic filament in a mass fraction of at least about 25 wt. %, such as at least about 50 wt. %, and up to about 95 wt. %.

In another embodiment, the energetic material comprises a propellant formulation. For example, the propellant formulation may include at least one of an inorganic oxidizer, an organic oxidizer, a high energy oxidizer, and mixtures thereof.

Examples of a propellant formulation include, but are not limited to, ammonium perchlorate, hydroxyl-terminated polybutadiene (HTPB), aluminum, octahydro-1,3,5,7-tetranitro-1,3,5,7-tetrazocine (HMX), nitrocellulose, and dinitrotoluene.

In another embodiment, the energetic material comprises a pyrotechnic formulation. For example, the pyrotechnic formulation may include at least one of a fuel/oxidizer pyrotechnic, a thermitic pyrotechnic, an intermetallic pyrotechnic, and mixtures thereof. One example of a fuel in a fuel/oxidizer pyrotechnic is an inorganic (e.g., metallic) including, but not limited to, aluminum, boron, magnesium, and titanium. Typical organic fuels include, but are not limited to, HTPB, polybutadiene acrylonitrile, pentaerythritol, and polybutadiene acrylic acid. Typical inorganic oxidizers include, but are not limited to, copper oxide, iron oxide, ammonium perchlorate, ammonium nitrate, potassium perchlorate, potassium nitrate, hexanitroethane, and ammonium dinitramide. Typical organic oxidizers include, but are not limited to, polytetrafluoroethylene and graphite fluoride. organic or inorganic fuel, or combinations thereof, depending on the energetic application. Typical inorganic fuels are, e.g., aluminum, boron, magnesium, and titanium. Typical organic fuels, are e.g., HTPB, polybutadiene acrylonitrile, pentaerythritol, and polybutadiene acrylic acid.

An example of a thermitic pyrotechnic is a mixture of aluminum metal particulates with copper (II) oxide particulates and/or with magnesium dioxide (MgO₂) particulates. An example of an intermetallic pyrotechnic is titanium and boron, which may also include particulate carbon.

The energetic thermoplastic filament also includes a thermoplastic elastomer. The thermoplastic elastomer may be substantially non-energetic thermoplastic elastomer (TPE), or may be an energetic thermoplastic elastomer (ETPE), or combinations thereof. TPEs may be selected from the group consisting of thermoplastic polyurethanes, thermoplastic olefins, thermoplastic polyamides, and thermoplastic co-polyesters.

ETPEs may be selected from, for example, energetic oxetane thermoplastic elastomers. Exemplary ETPEs and their copolymers are listed in Table I below.

TABLE I

| Energetic | | ETPE |
|---|---|---|
| Copolymer | Chemical Name | Example |
| AMMO | 3-azidomethyl-3-methyloxetane | BAMO/AMMO |
| BAMO | 3,3-bis(azidomethyl)oxetane | BAMO/NIMMO |
| GAP | glycidylazidopolymer | BAMO/GAP |
| NMMO | 3-nitratomethyl-3-methyloxetane | NMMO/THF |
| THF | tetrahydrofuran | AMMO/THF |

Other ETPEs suitable for use in high-energy compositions and the synthesis thereof are disclosed in U.S. Patent No. 5,210,153 by Manser et al., which is incorporated herein by reference in its entirety. Other ETPE-based formulations loaded with other energetic materials are described in U.S. Pat. No. 4,919,737 by Biddle et al.,m, U.S. Pat. No. 5,540,794 by Willer et al., U.S. Pat. No. 5,716,557 by Strauss et al., U.S. Pat. No. 6,508,894 by Beaupre et al., U.S. Pat. No. 6,562,159 by Ampleman et al., and U.S. Pat. No. 6,997,996 by Manning et al. Each of the foregoing U.S. patents is incorporated herein by reference in its entirety.

One common characteristic of the thermoplastic binders is that they must have a melting point that is below the thermal onset reaction temperature of the energetic material to prevent accidental combustion during extrusion through the heated nozzle (discussed below).

The energetic thermoplastic filament comprises a solid organic or inorganic oxidizer, or combinations thereof, depending on the energetic application. Typical organic oxidizers are, e.g., polytetrafluoroethylene and graphite fluoride. The oxidizer is preferably contained in the energetic thermoplastic filament according to this reaction in mass fractions of at least about 25 wt. %, such as at least about 50 wt. %, and up to about 95 wt. %.

The energetic thermoplastic filament may also include one or more modifying agents. Modifying agents may be added to the energetic materials to tailor the desired performance, to aid in manufacturability, and to control insensitivity. Typical modifying agents include, but are not limited to, metallic fuels, blast enhancers, burn rate modifiers, dyes or colorants, surfactants, additional polymer or wax binders, and plasticizers. When used, the modifying agent(s) are preferably contained in the energetic thermoplastic filament in mass fractions of not greater than about 50 wt. %.

The present disclosure is also directed to methods for the fabrication of energetic thermoplastic filaments. In one embodiment, the constituents of the energetic thermoplastic filaments are in particulate form and may have a well-controlled particle size in the nanometer to micrometer size range. Thus, in one embodiment, the fabrication method includes milling one or more of the energetic thermoplastic filament constituents to achieve a desirable particle size. Milling of the constituents to a desired particle size may be performed, for example, with a chopper, a ball mill, a rod mill, a cryochopper, a cryom ill, an impact mill, or combinations thereof.

As is discussed above, the energetic thermoplastic filament constituents include at least one energetic material and at least one thermoplastic elastomer, e.g., TPE and/or ETPE. Depending on the desired processing method, the constituents are intimately mixed prior to being loaded into an extruder. Alternatively, the constituents may be intimately mixed within the extruder.

The constituents are then extruded through a heated nozzle to bind the energetic material within a thermoplastic matrix. Cooling of the extrudate immobilizes the energetic material within the thermoplastic matrix, thus creating the energetic thermoplastic filament.

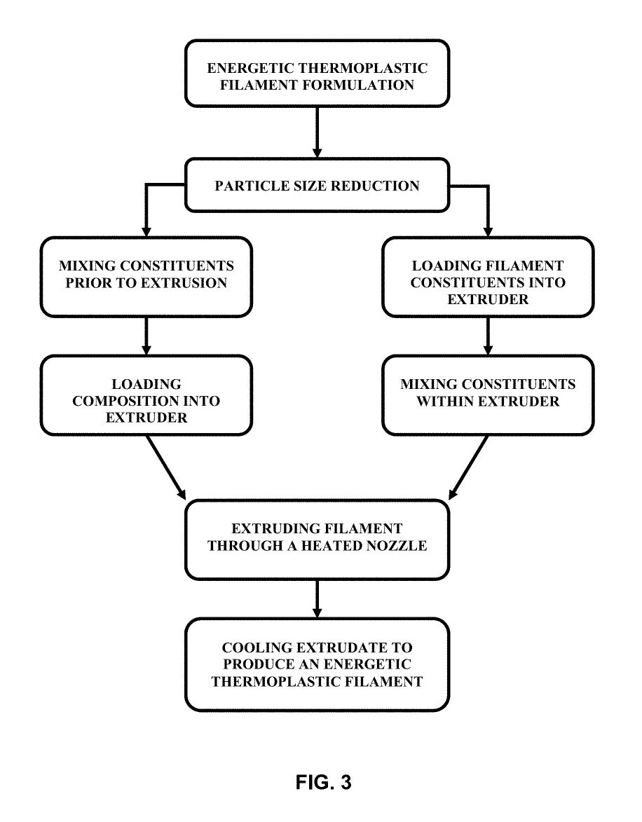

A further aspect of the disclosure relates to two different processes which can be used to manufacture energetic thermoplastic filaments, see the flowchart in FIG. 3. The first processing method comprises the following steps: (a) preparing thermoplastic and energetic material constituents by milling to a desirable particle size; (b) intimately blending the thermoplastic and energetic material constituents until the composition is homogeneous; (c) loading the prepared composition into a screw extruder and extruding the composition through a temperature controlled nozzle with a fixed nozzle diameter; and (d) cooling the extrudate to immobilize the energetic material within the thermoplastic matrix, thus creating an energetic thermoplastic filament.

For the second processing method, mixing of the constituent materials is performed within the extruder barrel. The second processing method includes the following steps: (a) preparing thermoplastic and energetic material constituents by milling to a desirable particle size; (b) loading the thermoplastic and energetic material constituents into a screw extruder and extruding the composition through a temperature controlled nozzle with a fixed nozzle diameter; and (c) cooling the extrudate to immobilize the energetic material within the thermoplastic matrix, thus creating an energetic thermoplastic filament.

The risk of accidental ignition of the energetic thermoplastic filament, the composition, or the constituents may be mitigated through the incorporation of a non-sparking mechanical assembly and an intrinsically safe design for the extruder, e.g., explosion proof components, thermal fuses, positive pressure/sealed subsystems, pneumatic components, hydronically heated components, and electrically grounded components.

Blending of the composition may be performed, by way of example and not by way of limitation, with a high shear mixer, dual asymmetric centrifugal mixer, alpha blade mixer, sigma blade mixer, resonant acoustic mixer, sonicator, v-mixer, multi-shaft mixer, or combinations thereof. Extruder mixing of the constituents within the barrel may be performed by dispersive mixing, distributive mixing, extensional mixing, or combinations thereof.

Loading compositions or constituents into the extruder may be assisted with a vibratory shaker, conveyor screw, conveyor belt, discharge elevator, drag conveyor, flood feeding, starve feeding, or combinations thereof.

The extruder may be, by way of example and not by way of limitation, a single screw extruder, twin screw extruder, triple screw extruder, ram extruder, combinations thereof. The extruder may be heated and temperature controlled by a hydronic heating system, an electric heating system, or combinations thereof. The extruder nozzle has a fixed inner nozzle diameter which yields filament having an outer diameter suitable for FDM AM (e.g., about 3 mm or about 1.75 mm).

The energetic thermoplastic extrudate is cooled by ambient air cooling, forced air cooling, a liquid bath, a chiller, or combinations thereof.

Similarly, for the formulation of the energetic thermoplastic filament to be used in FDM 3D printers, the energetic thermoplastic filament must have sufficient durability to be fed through a direct drive extruder, flexibility to be wound about a spool, strength to be handled, print and layer adhesion, filament cohesion, and ability to be extruded through a 3D printer hot end nozzle. The energetic material is preferably comprised in the greatest mass fraction possible while still maintaining the aforementioned desirable physical properties of the energetic thermoplastic filament. Thus, the energetic thermoplastic filament may have a mass fraction of the energetic material of at least about 25 wt. %, such as at least about 50 wt. %, and even at least about 75 wt. %. Typically, the mass fraction of the energetic material will not be greater than about 95 wt. %. When the energetic material is an oxidizer, it is preferably comprised in the stoichiometric mass fraction that provides for maximum combustion energy with the binder acting as a fuel, while still maintaining the aforementioned desirable physical properties of the energetic thermoplastic filament.

It is possible to use the processes and systems described herein to additively manufacture energetic devices and systems by either batch or continuous processing methods.

In one embodiment, a production process starts by milling the energetic thermoplastic filament constituents to a desirable particle size, if necessary. Energetic thermoplastic filament constituents comprise at least one energetic material and at least one TPE or ETPE, as is discussed above. Depending on the desired processing method, the constituents are intimately mixed prior to being loaded into the extruder or mixed within the extruder. Extrusion of the constituents through a heated nozzle binds the energetic material within a thermoplastic matrix. Cooling of the extrudate immobilizes the energetic material in the thermoplastic matrix, thus creating the energetic thermoplastic filament.

A further aspect of the disclosure therefore relates to two different processes which can be used to manufacture energetic thermoplastic filaments, see the flowchart in FIG. 3. The first processing method comprises the following steps: (a) preparing thermoplastic and energetic material constituents by milling to a desirable particle size; (b) intimately blending the thermoplastic and energetic material constituents until the composition is homogeneous; (c) loading the prepared composition into a screw extruder and extruding the composition through a temperature controlled nozzle with a fixed nozzle diameter; and (d) cooling the extrudate to immobilize the energetic material within the thermoplastic matrix, thus creating an energetic thermoplastic filament.

For the second processing method, mixing of the constituent materials is performed within the extruder barrel. The second processing method comprises the following steps: (a) preparing thermoplastic and energetic material constituents by milling to a desirable particle size; (b) loading the thermoplastic and energetic material constituents into a screw extruder and extruding the composition through a temperature controlled nozzle with a fixed nozzle diameter; and (c) cooling the extrudate to immobilize the energetic material within the thermoplastic matrix, thus creating an energetic thermoplastic filament.

The risk of accidental ignition of the energetic thermoplastic filament, the composition, or the constituents is mitigated through the incorporation of a non-sparking mechanical assembly and an intrinsically safe design, e,g., explosion proof components, thermal fuses, positive pressure/sealed sub systems, pneumatic components, hydronically heated components, and electrically grounded components.

Milling of the constituents to a desired particle size may be performed, by way of example and not by way of limitation, with a chopper, ball mill, rod mill, cryochopper, cryomill, impact mill, or combinations thereof.

Blending of the composition may be performed, by way of example and not by way of limitation, with a high shear mixer, dual asymmetric centrifugal mixer, alpha blade mixer, sigma blade mixer, resonant acoustic mixer, sonicator, v-mixer, multi-shaft mixer, or combinations thereof. Extruder mixing of the constituents within the barrel is performed by dispersive mixing, distributive mixing, extensional mixing, or combinations thereof.

Loading compositions or constituents into the extruder is assisted with a vibratory shaker, conveyor screw, conveyor belt, discharge elevator, drag conveyor, flood feeding, starve feeding, or combinations thereof.

The extruder may be, by way of example and not by way of limitation, a single screw extruder, twin screw extruder, triple screw extruder, ram extruder, combinations thereof. The extruder may be heated and temperature controlled by a hydronic heating system, an electric heating system, or combinations thereof. The extruder nozzle has a fixed inner nozzle diameter which yields filament having an outer diameter suitable for FDM AM (e.g., 3 mm or 1.75 mm).

The energetic thermoplastic extrudate may be cooled by ambient air cooling, forced air cooling, a liquid bath, a chiller, or combinations thereof.

### EXAMPLES

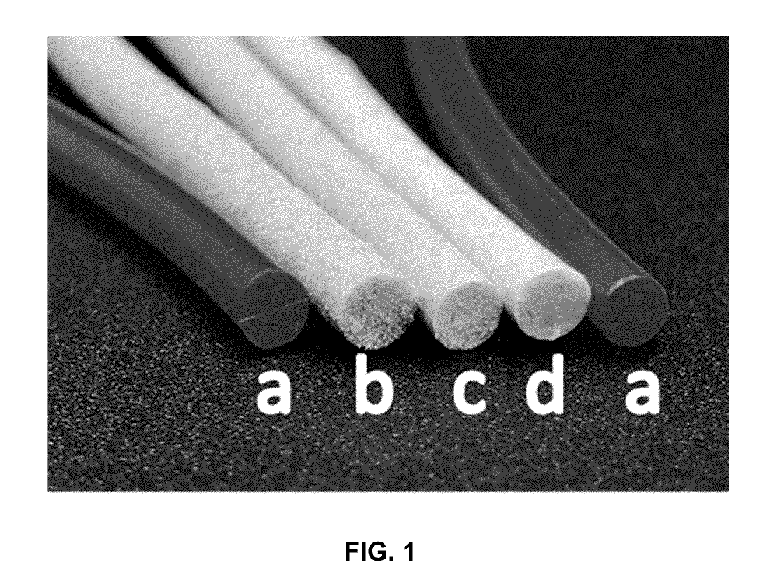

Preliminary work demonstrates the feasibility of extruding durable, flexible, 3 mm diameter TPE filaments with nitramine (HMX) loadings as high as 90 wt. %. FIG. 1 illustrates various examples of energetic thermoplastic filaments that are fabricated according to the present disclosure. Filament a is an example of a COTS TPE filament. Filament b is an energetic thermoplastic filament comprising about 50 wt. % HMX and about 50 wt. % TPE. Filament c is an energetic thermoplastic filament comprising about 70 wt. % HMX and about 30 wt. % TPE. Filament d is an energetic thermoplastic filament comprising about 90 wt. % HMX and about 10 wt. % TPE.

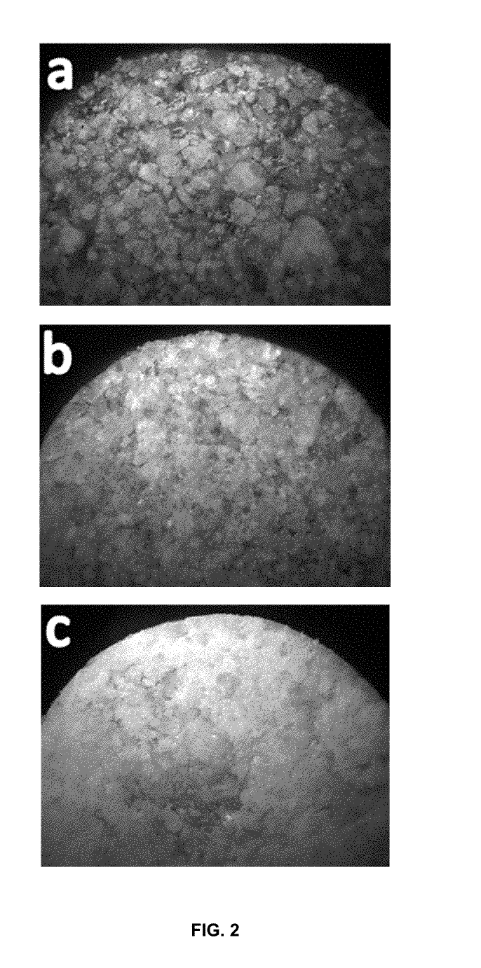

FIG. 2 illustrates cross sections of energetic thermoplastic filaments that are fabricated according to the present disclosure at 50× magnification. Filament a is an energetic thermoplastic filament comprising about 50 wt. % HMX and about 50 wt. % TPE. Filament b is an energetic thermoplastic filament comprising about 70 wt. % HMX and about 30 wt. % TPE. Filament c is an energetic thermoplastic filament comprising about 90 wt. % HMX and abot 10 wt. % TPE.

The extruded nitramine-based filaments illustrated in FIGS. 1 and 2 display promising durability and flexibility.

In another example, a COTS TPE filament (NINJAFLEX, available from Ninjatek, Manheim, Pa.) is pulverized into powder by cutting the filament into 1 inch sections and then cooling the filament in liquid nitrogen and subsequently chopping it in a food blender (Nutri Ninja). AP was milled in a dual asymmetric centrifugal mixing system (Flacktek SpeedMixer) with yttrium cylinders. HMX was received as a powder. Particle size analysis was performed by laser diffraction (Microtrac Bluewave). Mean particle size and particle size distribution of the constituents are listed in Table II.

TABLE II

| | D₁₀ | D₅₀ | D₉₀ |
|---|---|---|---|
| Constituent | (μm) | (μm) | (μm) |
| AP | 1.6 | 2.4 | 5.4 |
| HMX | 20.9 | 33.4 | 102.6 |
| TPE | 49.5 | 84.9 | 193.0 |

Each formulation is prepared by adding the respective constituents and isopropanol (as a processing fluid) to an electrostatic discharge (ESD) dissipative container and a high shear mixer (Flacktek SpeedMixer). The formulations are then transferred to an intrinsically safe explosives drying oven. Once dry, Differential Scanning Calorimetry/Thermogravimetric Analysis (DSC/TGA) is performed on milligram-quantity samples of the prepared formulations. DSC/TGA is performed with a TA Instruments SDT600, using a ramp rate of 20° C./min and ultra-high purity argon purge gas.

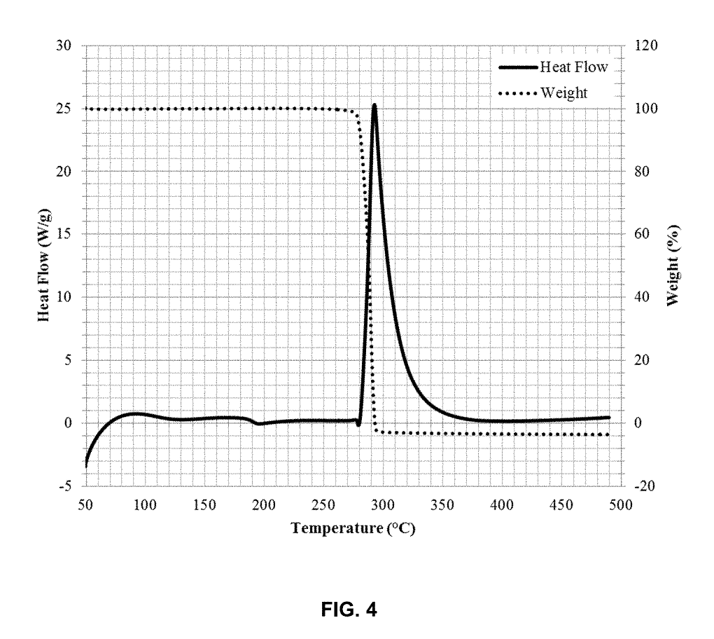

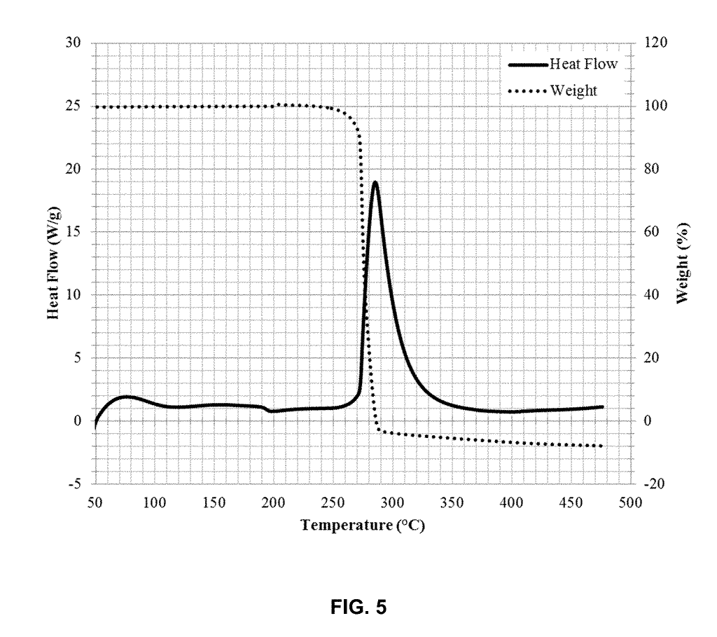

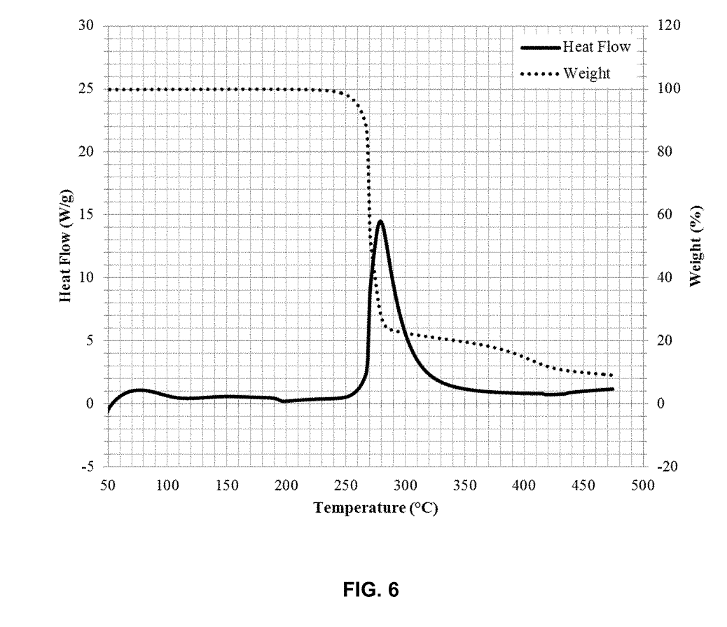

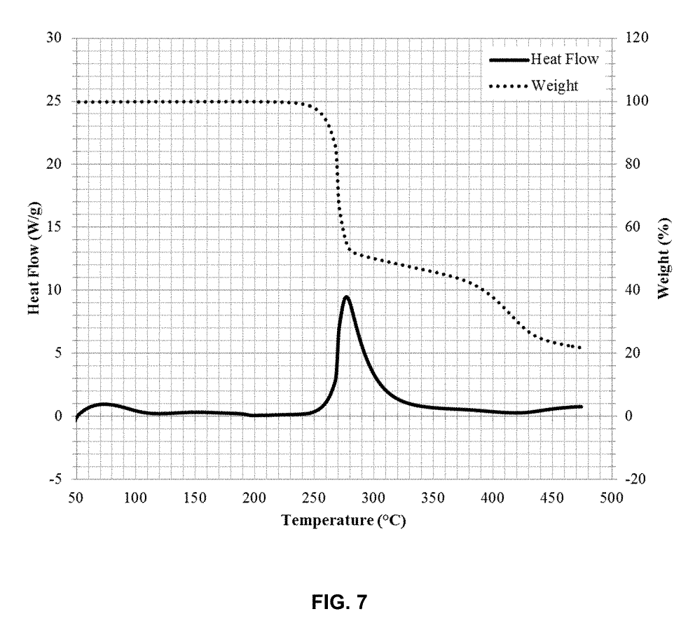

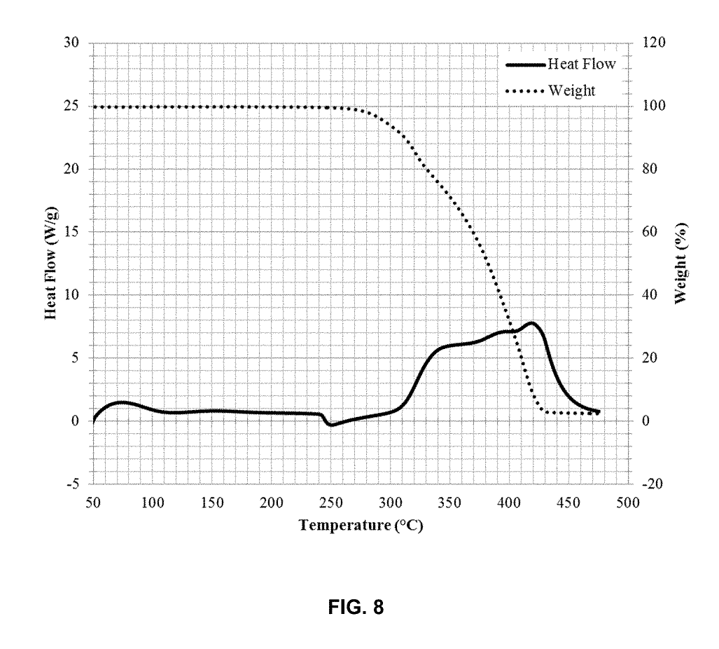

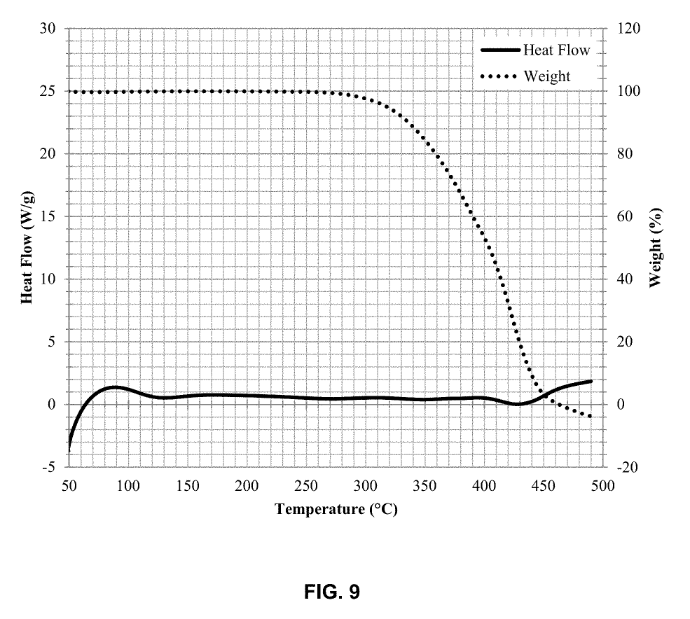

A thermal analysis of the prepared formulations is illustrated in FIGS. 4-9. Typically, formulations are mixed and filament is extruded as a single process in a twin-screw extruder; however, preparing and mixing formulations prior to single-screw extrusion allows for thermal analysis of the formulation and eliminates any uncertainty as to the homogeneity of the explosive mix. The benefit of this approach becomes quite apparent in the thermograms illustrated in FIGS. 4-9. The observed onset reaction temperature of the HMX/TPE formulations shifts to a lower temperature as the mass fraction of HMX decreases—an unexpected but significant result in regards to safe extrusion temperatures. These values are also listed in Table III.

TABLE III

| | Combustion | Onset | |
|---|---|---|---|
| | Enthalpy | Temperature | Mass Loss |
| Formulation | (J/g) | (° C.) | (%) |
| HMX | 1674 | 283 | 100.0 |
| HMX/TPE (50/50) | 798 | 265 | 48.3 |
| HMX/TPE (70/30) | 1191 | 268 | 76.3 |
| HMX/TPE (90/10) | 1504 | 272 | 100.0 |
| AP/TPE (74/26) | 2158 | 310 | 97.1 |
| TPE | N/A | N/A | N/A |

Typically, formulations are mixed and filament is extruded as a single process in a twin-screw extruder. However, is has been found that preparing and mixing the filament formulations prior to single-screw extrusion allows for thermal analysis of the formulation and reduces any uncertainty as to the homogeneity of the energetic mix. The benefit of this approach becomes quite apparent in the thermograms, in which the observed onset reaction temperature of the HMX/TPE formulations shifts to a lower temperature as the mass fraction of HMX decreases—an unexpected but significant result in regards to safe extrusion temperatures.

To observe the effects of a single screw extruder, a commercially available single screw extruder specifically designed for thermoplastic FDM filaments (Filastruder) is modified. Modifications are made to the extruder to minimize the amount of material required to produce a sample filament. A one-quarter inch (6.4 mm) diameter, non-sparking stainless steel barrel and auger are fabricated, and the feed hopper is replaced with a stainless funnel. During extrusion, the modified single screw extruder is contained inside a barricade with ¾″ thick steel walls inside a ballistic test chamber. Control wires are extended to allow for remote operation in a room adjacent to the ballistic test chamber. The funnel is loaded with 2 grams of energetic material, and the steel barricade and test chamber door were closed. The extruder nozzle is heated to 210° C. and then the auger motor is powered on. Extrusion is monitored using an IP camera and the auger is stopped once about 6 inches of filament is extruded.

While various embodiments of energetic thermoplastic filaments and methods for their manufacture have been described in detail, it is apparent that modifications and adaptations of those embodiments will occur to those skilled in the art. However, it is to be expressly understood that such modifications and adaptations are within the spirit and scope of the present disclosure.

1. A method for the fabrication of an energetic thermoplastic filament, comprising the steps of:
providing an energetic thermoplastic composition to an extruder, the energetic thermoplastic composition comprising an energetic material and a thermoplastic elastomer;
extruding the energetic thermoplastic composition through an orifice of a heated nozzle to form an extrudate; and
reducing the temperature of the extrudate to immobilize the energetic material within a thermoplastic matrix and form the energetic thermoplastic filament.

2. The method recited in claim 1, comprising the step of:
reducing the particle size of the energetic thermoplastic composition constituents before providing the composition to the extruder.

3. The method recited in claim 2, wherein the step of reducing the particle size comprises placing the thermoplastic composition constituents in a device selected from the group consisting of a chopper, a ball mill, a rod mill, a cryochopper, a cryomill, an impact mill, and combinations thereof.

4. The method recited in claim 1, comprising the step of:
mixing the energetic thermoplastic composition into a homogeneous composition before providing the composition to the extruder.

5. The method recited in claim 4, wherein the mixing step comprises mixing the energetic thermoplastic composition constituents in a device selected from the group consisting of a high shear mixer, a dual asymmetric centrifugal mixer, an alpha blade mixer, a sigma blade mixer, a resonant acoustic mixer, a sonicator, a v-mixer, a multi-shaft mixer, and combinations thereof.

6. The method recited in claim 1, wherein the step of providing the energetic thermoplastic composition to the extruder includes providing the composition using a device selected from the group consisting of a vibratory shaker, a conveyor screw, a conveyor belt, a discharge elevator, a drag conveyor, a flood feeder, a starve feeder, and combinations thereof.

7. The method recited in claim 1, wherein the extruder is heated and temperature-controlled using a system selected from a hydronic heating system, an electric heating system, and combinations thereof.

8. The method recited in claim 1, wherein the heated nozzle has an inner nozzle diameter of at least about 1.5 mm.

9. The method recited in claim 1, wherein the heated nozzle has an inner nozzle diameter of not greater than about 4.0 mm.

10. The method recited in claim 1, wherein the heated nozzle is heated to a temperature of at least about 100° C.

11. The method recited in claim 1, wherein the heated nozzle is heated to a temperature of not greater than about 400° C.

12. The method recited in claim 1, wherein the cooling step comprises cooling the energetic thermoplastic extrudate in ambient air.

13. The method recited in claim 1, wherein the cooling step comprises cooling the energetic thermoplastic extrudate by forced air cooling, in a liquid bath, in a chiller, or combinations thereof.

14. The method recited in claim 1, wherein the extruder is a single screw extruder.

15. An energetic thermoplastic filament comprising an energetic material and a thermoplastic elastomer, wherein the energetic material is bound and immobilized homogeneously within a thermoplastic elastomer matrix.

16. The energetic thermoplastic filament recited in claim 15, wherein the thermoplastic elastomer comprises a non-energetic thermoplastic elastomer.

17. The energetic thermoplastic filament recited in claim 15, wherein the thermoplastic elastomer comprises an energetic thermoplastic elastomer.

18. The energetic thermoplastic filament recited in any on claim 17, wherein the thermoplastic elastomer comprises an energetic oxetane.

19. The energetic thermoplastic filament recited in claim 15, wherein the energetic material comprises an explosive formulation.

20. The energetic thermoplastic filament recited in claim 19, wherein the explosive formulation comprises at least one of a primary explosive, a secondary explosive, a tertiary explosive, and mixtures thereof.

21-33. (canceled)
